(19) United States
(12) Patent Application Publication
(10) Pub. No.: US 2005/0107580 A1
(43) Pub. Date: May 19, 2005

(54) Epoxy polymer precursors and epoxy polymers resistant to damage by high-energy radiation

(76) Inventors: Sean Elliot Armstrong, Albany, NY (US); Wendy Wen-Ling Lin, Niskayuna, NY (US); Alan Ilya Kasner, Wadsworth, IL (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/971,393

(22) Filed: Oct. 25, 2004

Related U.S. Application Data
(62) Division of application No. 10/171,368, filed on Jun. 12, 2002.

(51) Int. Cl. C08L 63/00

(52) U.S. Cl. 528/418; 528/421

(57) ABSTRACT

Epoxy polymer precursors and epoxy polymers resulting therefrom are tolerant to bombardment by high-energy radiation. The epoxy polymer precursors comprise at least an epoxy resin free of aromatic units and at least a curing agent selected from the group consisting of aliphatic polyamines, cycloaliphatic polyamines, polyamides, aliphatic anhydrides, cycloaliphatic anhydrides, and mixtures thereof. In one embodiment of the invention the epoxy resin comprises at least a cycloparaffinic group, and the curing agent comprises a polyamine derived from cyclohexane. Such epoxy polymer compositions are used to form reflectors elements between adjacent scintillator elements in high-energy radiation detector array.

### BACKGROUND OF THE INVENTION

The present invention relates to polymer precursor compositions and polymers resulting therefrom that are resistant to damage by high-energy radiation. In particular, the present invention relates to such polymer precursor compositions and polymers that are resistant to damage by X radiation. The present invention also relates to X-ray detectors using such polymers.

Radiation imaging systems are widely used for medical and industrial purposes, such as for computed tomography (“CT”) and luggage scanning. Imaging systems have been developed that use detected radiation to produce signals that can be further processed to display an image of the object under examination. High-energy radiation such as X or gamma radiation have been used in various imaging systems. In such systems, the radiation is typically absorbed in a scintillator material, resulting in generation of photons of light. Light photons emanating from the scintillator are detected by photodetectors to generate an electrical output signal that can be processed to drive a display device or an analysis system.

A scintillator array comprises many individual scintillator elements assembled with reflectors disposed therebetween. The reflector is to prevent or minimize the transmission of visible light from one scintillator element to an adjacent one and to channel visible light from the scintillator element to the corresponding photodiode for detection. Such transmission or “leakage” of visible light, commonly referred to as cross talk, results in an image of poorer quality. Each scintillator element is optically coupled to a photomultiplier tube that converts the light emitted from the scintillator element to an electrical signal for further processing. Each scintillator element and corresponding photomultiplier tube form a “channel” in the whole detector.

One known method of forming a reflector between scintillator elements is the use of polymeric bonding material as the reflector. A commonly used bonding material is bisphenol-A (“BPA”)-based epoxy resin that hardens upon curing with an amine. The polymeric bonding material is typically mixed with light-scattering particles that reflect light back to the originating scintillator element. Prior-art polymeric bonding materials have several disadvantages. Typically, they have high viscosity, which makes it difficult to fabricate high-precision scintillator arrays. Furthermore, typical polymeric bonding materials are not very resistant to damage by high-energy radiation. Absorption of high-energy radiation by these polymeric materials rapidly leads to loss of light transparency and increase in light absorption therein, which in turn leads to lower amount of light detected by the photomultiplier tube or photodiode.

Therefore, there is a continued need to provide polymeric bonding materials that are more resistant to damage by high-energy radiation. In particular, it is very desirable to provide polymeric bonding materials, the light transparency of which does not substantially change upon being exposed to high-energy radiation over an extended period of time. Furthermore, it is also desirable to provide polymeric bonding materials that are easily processed and applied in the manufacture of scintillator arrays.

### BRIEF SUMMARY OF THE INVENTION

The present invention provides curable epoxy resin compositions that are highly suitable for use in forming reflector elements between adjacent scintillator elements in a detector array of a high-energy radiation detecting system. A curable epoxy resin composition of the present invention comprises: (a) at least an epoxy resin having a plurality of oxirane groups and being devoid of aromatic units; and (b) at least one curing agent selected from the group consisting of aliphatic polyamines, cycloaliphatic polyamines, polyamides, aliphatic anhydrides, cycloaliphatic anhydrides, and mixtures thereof.

In one aspect of the present invention, a light-scattering composition comprises: (a) a curable epoxy resin composition that comprises: (1) at least an epoxy resin having a plurality of oxirane groups and is devoid of aromatic units; and (2) at least one curing agent selected from the group consisting of aliphatic polyamines, cycloaliphatic polyamines, polyamides, aliphatic anhydrides, cycloaliphatic anhydrides, and mixtures thereof; and (b) particles of at least a light-scattering material dispersed in said curable epoxy resin composition.

In another aspect of the present invention, a reflector element in a high-energy radiation detector comprises the light-scattering composition disclosed above.

In still another aspect of the present invention, a method of forming a reflector element in a detector array of a high-energy radiation detecting system, which detector array comprises a plurality of adjacent scintillator elements, comprises: (a) providing a light-scattering composition which comprises: (1) a curable epoxy resin composition that comprises: (A) at least an epoxy resin having a plurality of oxirane groups and being devoid of aromatic units; and (B) at least one curing agent selected from the group consisting of aliphatic polyamines, cycloaliphatic polyamines, polyamides, aliphatic anhydrides, cycloaliphatic anhydrides, and mixtures thereof; and (2) particles of at least a light-scattering material dispersed in said curable epoxy resin composition; (b) applying the light-scattering composition in a space between two adjacent scintillator elements; and (c) curing the curable epoxy resin composition to form the reflector element.

Other features and advantages of the present invention will be apparent from a perusal of the following detailed description of the invention and the accompanying drawings in which the same numerals refer to like elements.

### BRIEF DESCRIPTION OF THE DRAWINGS

FIG. 1 illustrates a method of making a detector array comprising a plurality of scintillator pixels separated by a light-scattering epoxy composition of the present invention.

FIG. 2 illustrates an alternative method of making a detector array that uses a light-scattering epoxy composition of the present invention.

### DETAILED DESCRIPTION OF THE INVENTION

Epoxy resins that can be used for the present invention comprise those that could be produced by reaction of a hydroxyl, carboxyl or amine-containing compound with epichlorohydrin, preferably in the presence of a basic catalyst, such as a metal hydroxide, for example sodium hydroxide. Epoxy resins that can be used for the present invention also comprise those that could be produced by reaction of a compound containing at least one and preferably two or more carbon-carbon double bonds with a peroxide, such as a peroxyacid.

The present invention provides curable epoxy resin compositions that comprise: (a) at least an epoxy resin having a plurality of oxirane groups and being devoid of aromatic units; and (b) at least a curing agent selected from the group consisting of aliphatic polyamines, cycloaliphatic polyamines, polyamides, aliphatic anhydrides, cycloaliphatic anhydrides, and mixtures thereof. The term “aromatic unit” means a group of one or more substituted or unsubstituted unsaturated cyclic hydrocarbons containing one or more six-carbon rings.

In various embodiments epoxy resins for the present invention can comprise aliphatic and/or cycloaliphatic epoxy resins. Aliphatic epoxy resins of epoxy resin compositions of the present invention comprise compounds that contain at least one aliphatic group and a plurality of epoxy groups. Examples of aliphatic epoxies comprise butadiene dioxide, dimethylpentane dioxide, diglycidyl ether, 1,4-butanedioldiglycidyl ether, diethylene glycol diglycidyl ether, dipentene dioxide, and polyoldiglycidyl ether. A suitable aliphatic epoxy resin is 1,4-butanedioldiglycidyl ether.

Other aliphatic epoxy resins suitable for a curable epoxy resin composition of the present invention comprise those that have one or more cycloparaffinic groups. The term “cycloparaffinic group” means a group of substituted or unsubstituted saturated cyclic hydrocarbons containing one or more rings, each ring having 3-10 carbon atoms. Non-limiting examples of this class of aliphatic epoxy resins are: 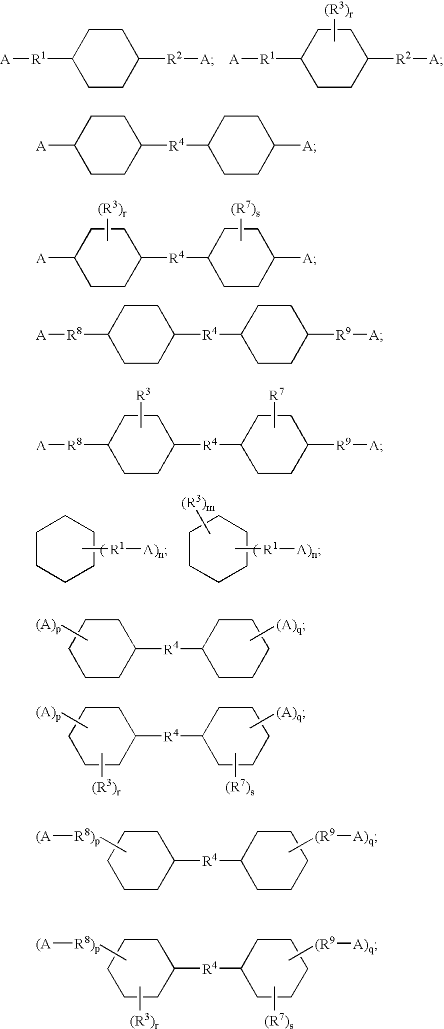
and mixtures thereof; wherein A represents the glycidyl ether group

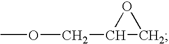

R¹ and R² are independently selected from the group consisting of straight-chain saturated hydrocarbon, branched-chain saturated hydrocarbon, straight-chain unsaturated hydrocarbon, branched-chain unsaturated hydrocarbon, and halogenated hydrocarbon divalent radicals having 1-10 carbon atoms;

R³ and R⁷ are independently selected from the group consisting of OH, alkyl, alkenyl, hydroxyalkyl, hydroxyalkenyl, and alkoxy radicals having 1-10 carbon atoms;

R⁴, R⁸, and R⁹ are independently selected from the group consisting of —C(R⁵)(R⁶)—, R¹, R², hydroxyalkyl, hydroxyalkenyl, —R¹—N(R²)(R⁵)—, and —R¹—S—R²—, wherein R⁵ and R⁶ are independently selected from the group consisting of H, OH, alkyl, alkoxy, hydroxyalkyl, alkenyl, and hydroxyalkenyl radicals having 1-10 carbon atoms;

n is an integer from 2 to 6, inclusive;

m is an integer from 0 to 4, inclusive;

2≦m+n≦6;

p and q are independently selected from the group of integers from 1 to 5, inclusive;

r and s are independently selected from the group of integers from 0 to 4, inclusive;

2≦p+r≦5; and 2≦q+s≦5.

Cycloaliphatic epoxy resins suitable for an epoxy resin composition of the present invention are compounds that contain at least about one cycloaliphatic group and at least one oxirane group. In various embodiments, cycloaliphatic epoxies comprise compounds that contain at least one cycloaliphatic group and at least two oxirane rings per molecule. Specific examples comprise 2-(3,4-epoxy)cyclohexyl-5, 5-spiro-(3,4-epoxy)cyclohexane-m-dioxane, 3,4-epoxycyclohexylmethyl-3,4-epoxycyclohexanecarboxylate, 3,4-epoxy-6-methylcyclohexylmethyl-3,4-epoxy-6-methylcyclohexanecarboxylate, vinyl cyclohexanedioxide, bis(3,4-epoxycyclohexylmethyl)adipate, bis(3,4-epoxy-6-methylcyclohexylmethyl)adipate, exo-exo bis(2,3-epoxycyclopentyl)ether, endo-exo bis(2,3-epoxycyclopentyl)ether, 2,2-bis(4-(2,3-epoxypropoxy)cyclohexyl)propane, 2,6-bis(2,3-epoxypropoxycyclohexyl-p-dioxane), 2,6-bis(2,3-epoxypropoxy)norbornene, the diglycidylether of linoleic acid dimer, limonene dioxide, 2,2-bis(3,4-epoxycyclohexyl)propane, dicyclopentadiene dioxide, 1,2-epoxy-6-(2,3-epoxypropoxy)hexahydro-4,7-methanoindane, 1,2-bis{5-(1,2-epoxy)-4,7-hexahydro-methanoindanoxyl}ethane, cyclohexanediol diglycidyl ether, and diglycidyl hexahydrophthalate. In particular embodiments, cycloaliphatic epoxy resins are 3,4-epoxycyclohexylmethyl-3,4-epoxycyclohexanecarboxylate and 3,4-epoxy-6-methylcyclohexylmethyl-3,4-epoxy-6-methylcyclohexanecarboxylate.

A curable epoxy resin formulation of the present invention may comprise a plurality of epoxy resins selected from those disclosed above so as to produce a formulation having a desired property before or after curing, such as a desired viscosity, cure temperature, or glass transition temperature.

Also useful are aliphatic epoxy resins that may be used as flexibilizers in the formulation. These comprise aliphatic epoxy resins, such as butanedioldiglycidyl ether and siloxane resins.

Curing agents suitable for use as a component of a curable epoxy resin composition of the present invention are polyamines, polyamides, polyacids and their anhydrides, polymercaptans, and polyphenols. These curing agents effect a polyaddition reaction of the epoxy resin monomers or oligomers via an active hydrogen and a terminal carbon of the epoxide group, with a subsequent conversion of the epoxide into a hydroxyl group.

Suitable polyamine curing agents are aliphatic polyamines and cycloaliphatic polyamines, such as those disclosed in Clayton A. May and Yoshio Tanaka (Ed.), “Epoxy Resins, Chemistry And Technology,” Marcel Dekker (1973), chapters 3 and 4. Non-limiting examples of polyamine curing agents are ethylenediamine; diethylenetriamine; triethylenetetramine; hexamethylenediamine; diethylaminopropylamine; menthanediamine (4-(2-aminopropane-2-yl) 1-methylcyclohexane-1-amine); silicon-containing polyamines; N-aminoethyl piperazine; olefin oxide-polyamine adducts such as H₂N—(CH₂CH₂NH)₂—(CH₂)₂OH, H₂N—R¹—NH—(CH₂)₂OH, H₂N—(CH₂)₂—NH—R¹—NH—(CH₂)₂OH; glycidyl ether-polyamine adducts such as R¹⁰—(O—CH₂—CH(OH)—CH₂—NH—(CH₂)₂NH—(CH₂)₂—NH₂)₂; ketimines (R¹⁰(R¹¹)C—NR¹—NH—R²—NCR¹⁰(R¹¹)); wherein R¹ and R² are defined above, and R¹⁰ and R¹¹ are independently selected from the group consisting of H, alkyl, alkenyl, hydroxyalkyl, and hydroxyalkenyl radicals having 1-10 carbon atoms. Suitable cycloaliphatic polyamines are those derived from cycloaliphatic hydrocarbons, such as isophorone diamine having the formula

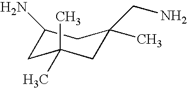

and 1,2-diaminocyclohexane. Other cycloaliphatic polyamines are derivatives of piperazine, such as N-aminoethylpiperazine. A preferred cycloaliphatic polyamine is isophorone diamine.

Suitable polyamides are alkyl/alkenyl imidazolines represented by the formula
R¹⁰—(C(O)NH—R¹)ᵤ—NH—R²—NH₂,

wherein R¹, R², and R¹⁰ are defined above, and u is an integer from 1-10, inclusive.

Suitable acid anhydrides for use as a curing agent in a curable epoxy resin composition of the present invention are methylbicyclo(2.2.1)heptene-2,3-dicarboxylic anhydride; tetraahydrophthalic anhydride; hexahydrophthalic anhydride; methylhexahydrophthalic anhydride (“MHHPA”); succinic anhydride; dodecenyl succinic anhydride; 1,4,5,6,7,7-hexachlorobicyclo(2.2.1)-5-heptene-2,3-dicarboxylic anhydride, endo-cis-bicyclo(2.2.1)heptene-2,3-dicarboxylic anhydride, tetrachlorophthalic anhydride, pyromellitic dianhydride, anhydride of 1,2,3,4-cyclopentanetetracarboxylic acid. A preferred acid anhydride curing agent is MHHPA.

Stoichiometric ratios of the multifunctional curing agent to epoxy resin approaching 1:1 are usually preferred to obtain optimum thermoset properties. However, deviations up to about 25 percent, preferably up to about 10 percent, from such stoichiometric ratios are tolerable in many circumstances. When a curing agent is an anhydride, a ratio of anhydride to epoxy resin may be as low as 0.2-0.5:1.

In addition to curing agents, cure modifiers may be added into a curable epoxy resin composition of the present invention to modify the rate of cure of the epoxy resin. In various embodiments, cure modifiers useful in the present invention can comprise one of cure accelerators or cure inhibitors. Cure modifiers may comprise compounds containing heteroatoms that possess lone electron pairs. In various embodiments cure modifiers comprise alcohols such as polyfunctional alcohols such as diols, triols, etc., and bisphenols, trisphenols, etc. Further, the alcohol group in such compounds may be primary, secondary or tertiary, or mixtures thereof. In particular embodiments the alcohol group is secondary or tertiary. Representative examples comprise benzyl alcohol, cyclohexanemethanol, alkyl diols, cyclohexanedimethanol, ethylene glycol, propylene glycol, butanediol, pentanediol, hexanediol, heptanediol, octanediol, polyethylene glycol, glycerol, polyether polyols such as those sold under the trade name VORANOL by the Dow Chemical Company, and the like. Phosphites may also be used as cure modifiers. Illustrative examples of phosphites comprise trialkylphosphites, triarylphosphites, trialkylthiophosphites, and triarylthiophosphites. In some embodiments phosphites comprise triphenyl phosphite, benzyldiethyl phosphite, or tributyl phosphite. Other suitable cure modifiers comprise sterically hindered amines and 2,2,6,6-tetramethylpiperidyl residues, such as for example bis(2,2,6,6-tetramethylpiperidyl)sebacate. Mixtures of cure modifiers may also be employed.

In addition to epoxy resins and curing agents, one or more ancillary curing catalysts can be optionally added into the composition. In various embodiments, the ancillary curing catalyst comprises an organometallic salt, a sulfonium salt, or an iodonium salt. In particular embodiments, the ancillary curing catalyst comprises at least one of a metal carboxylate, a metal acetylacetonate, zinc octoate, stannous octoate, triarylsulfonium hexafluorophosphate, triarylsulfonium hexafluoroantimonate (such as CD 1010 sold by Sartomer Corporation), diaryliodonium hexafluoroantimonate, or diaryliodonium tetrakis(pentafluorophenyl)borate. In various embodiments, the amount of ancillary curing catalyst is less than about 10 percent by weight based on the combined weight of the curable epoxy resin composition. In other embodiments, the amount of ancillary curing catalyst is from about 0.05 percent by weight to about 10 percent by weight based on the combined weight of the curable epoxy resin composition.

The present invention also provides a light-scattering composition comprising: (a) a curable epoxy resin composition that comprises: (1) at least an epoxy resin having a plurality of oxirane groups and is devoid of aromatic units; and (2) at least one curing agent selected from the group consisting of aliphatic polyamines, cycloaliphatic polyamines, polyamides, aliphatic anhydrides, cycloaliphatic anhydrides, and mixtures thereof; and (b) particles of at least a light-scattering material dispersed in said curable epoxy resin composition. The size of the particles of the at least a light-scattering material is typically in the range of about 100-2000 nm, preferably about 100-400 nm, and more preferably about 250-350 nm. Suitable light-scattering materials are compounds of Groups II, III, IV, V, and VI of the Periodic Table. Non-limiting examples are titanium oxide, zirconium oxide, hafnium oxide, aluminum oxide, gallium oxide, indium oxide, yttrium oxide, cerium oxide, zinc oxide, magnesium oxide, calcium oxide, zinc selenide, zinc sulphide, gallium nitride, silicon nitride, aluminum nitride, or alloys of two or more metals of Groups II, III, IV, V, and VI. A preferred light-scattering material is titanium oxide. A light-scattering material can typically comprise from about 10 to about 85 percent by weight of the total light-scattering composition. For example, for TiO₂ the amount is about 50 weight percent. It is to be understood that this amount may be optimized for other light-scattering materials that may have densities different than that of TiO₂ and for the specific application. Particles of the light-scattering material can be dispersed in an epoxy resin composition by, for example, a high-shear mixer operated up to 4000-5000 rpm (revolutions per minute). In addition, particles of a radiation-damage control material, such as chromium oxide, may be advantageously added into the formulation so as substantially to absorb stray high-energy radiation.

One or more thermal stabilizers or radiation stabilizers or mixtures thereof may optionally be present in the compositions of the invention. Such stabilizers may reduce color formation during processing of the polymer. Suitable stabilizers to improve the thermal and/or stability under radiation bombardment are described, for example, in J. F. Rabek, “Photostabilization of Polymers; Principles and Applications”, Elsevier Applied Science, NY, 1990 and in “Plastics Additives Handbook”, 5th edition, edited by H. Zweifel, Hanser Publishers, 2001. Illustrative examples of suitable stabilizers comprise organic phosphites and phosphonites, such as triphenyl phosphite, diphenylalkyl phosphites, phenyldialkyl phosphites, tri-(nonylphenyl)phosphite, trilauryl phosphite, trioctadecyl phosphite, di-stearyl-pentaerythritol diphosphite, tris-(2,4-di-tert-butylphenyl)phosphite, di-isodecylpentaerythritol diphosphite, di-(2,4-di-tert-butylphenyl)pentaerythritol diphosphite, tristearyl-sorbitol triphosphite, and tetrakis-(2,4-di-tert-butylphenyl)-4,4′-biphenyldiphosphonite. Illustrative examples of suitable stabilizers also comprise sulfur-containing phosphorus compounds such as trismethylthiophosphite, trisethylthiophosphite, trispropylthiophosphite, trispentylthiophosphite, trishexylthiophosphite, trisheptylthiophosphite, trisoctylthiophosphite, trisnonylthiophosphite, trislaurylthiophosphite, trisphenylthiophosphite, trisbenzylthiophosphite, bispropiothiomethylphosphite, bispropiothiononylphosphite, bisnonylthiomethylphosphite, bisnonylthiobutylphosphite, methylethylthiobutylphosphite, methylethylthiopropiophosphite, methylnonylthiobutylphosphite, methylnonylthiolaurylphosphite, and pentylnonylthiolaurylphosphite. These compounds can be used singly or in a combination of at least two compounds.

Suitable stabilizers also comprise sterically hindered phenols which are known in the art. Illustrative examples of sterically hindered phenol stabilizers comprise 2-tertiary-alkyl-substituted phenol derivatives, 2-tertiary-amyl-substituted phenol derivatives, 2-tertiary-octyl-substituted phenol derivatives, 2-tertiary-butyl-substituted phenol derivatives, 2,6-di-tertiary-butyl-substituted phenol derivatives, 2-tertiary-butyl-6-methyl- (or 6-methylene-) substituted phenol derivatives, and 2,6-di-methyl-substituted phenol derivatives. These compounds can be used singly or in a combination of at least two compounds. In certain particular embodiments sterically hindered phenol stabilizers comprise alpha-tocopherol and butylated hydroxy toluene.

Suitable stabilizers also comprise sterically hindered amines, illustrative examples of which comprise bis-(2,2,6,6-tetramethylpiperidyl)sebacate, bis-(1,2,2,6,6-pentamethylpiperidyl)sebacate, n-butyl-3,5-di-tert-butyl-4-hydroxybenzyl malonic acid bis-(1,2,2,6,6-pentamethylpiperidyl)ester, condensation product of 1 -hydroxyethyl-2,2,6,6-tetramethyl-4-hydroxypiperidine and succinic acid, condensation product of N,N′-(2,2,6,6-tetramethylpiperidyl)-hexamethylenediamine and 4-tert-octyl-amino-2,6-dichloro-s-triazine, tris-(2,2,6,6-tetramethylpiperidyl)-nitrilotriacetate, tetrakis-(2,2,6,6-tetramethyl-4-piperidyl)-1,2,3,4-butanetetracarboxylate, and 1,1′-(1,2-ethanediyl)-bis-(3,3,5,5-tetramethylpiperazinone). These compounds can be used singly or in a combination of at least two compounds.

Suitable stabilizers also comprise compounds which destroy peroxide, illustrative examples of which comprise esters of beta-thiodipropionic acid, for example the lauryl, stearyl, myristyl or tridecyl esters; mercaptobenzimidazole or the zinc salt of 2-mercaptobenzimidazole; zinc dibutyl-dithiocarbamate; dioctadecyl disulfide; and pentaerythritol tetrakis-(beta-dodecylmercapto)-propionate. These compounds can be used singly or in a combination of at least two compounds.

Optional components in the present invention also comprise coupling agents which in various embodiments may help epoxy resin bind to a matrix, such as a glass matrix, so as to form a strong bond to the surface such that premature failure does not occur. Coupling agents comprise compounds that contain both silane and mercapto moieties, illustrative examples of which comprise mercaptomethyltriphenylsilane, beta-mercaptoethyltriphenylsilane, beta-mercaptopropyltriphenylsilane, gamma-mercaptopropyldiphenylmethylsilane, gamma-mercaptopropylphenyldimethylsilane, delta-mercaptobutylphenyldimethylsilane, delta-mercaptobutyltriphenylsilane, tris(beta-mercaptoethyl)phenylsilane, tris(gamma-mercaptopropyl)phenylsilane, tris(gamma-mercaptopropyl)methylsilane, tris(gamma-mercaptopropyl)ethylsilane, and tris(gamma-mercaptopropyl)benzylsilane. Coupling agents also comprise compounds which comprise both an alkoxysilane and an organic moiety, illustrative examples of which comprise compounds of the formula (R²⁰O)₃Si—R²¹ wherein R²⁰ is an alkyl group and R²¹ is selected from the group consisting of vinyl, 3-glycidoxypropyl, 3-mercaptopropyl, 3-acryloxypropyl, 3-methacryloxypropyl, and CₖH₂ₖ₊₁. In some embodiments R²⁰ is methyl or ethyl, and k has the value of 4-16, inclusive. In other embodiments coupling agents comprise those comprising both an alkoxysilane and an epoxy moiety. Coupling agents can be used singly or in a combination of at least two compounds.

Epoxy resin compositions used to form reflectors in radiation detector arrays desirably have a plurality of the following properties:

Viscosity of Uncured Composition

| | |
|---|---|
| Without Solid Light-scattering Particles | ≦500 cP (or 0.5 kg/m/sec), |
| | preferably ≦100 cP |
| With Solid Light-scattering Particles | ≦2000 cP (or 2 kg/m/sec), |
| | preferably ≦500 cP |

Properties of Cured Composition

| | |
|---|---|
| Optical Transmission at 610 nm Through 1 mm | >90% |
| (Without Filler) | |
| X-ray Degradation (as Measured by Transmission Loss | <5% |
| After Receiving a Dose of 1.3 Mrad) (Without Filler) | |
| Glass Transition Temperature | >40° C., |
| | preferably |
| | >65° C. |
| Cure Shrinkage (With Solid Light-scattering Particles) | ≦5% |
| Pot Life | ≧50 minutes |
| Cure Temperature | <150° C., |
| | preferably |
| | 50-85° C. |

Curable compositions comprising aliphatic or cycloaliphatic epoxy resins were prepared with aliphatic or cycloaliphatic curing agents and tested. Viscosity of the uncured composition, glass transition temperature, and transmission loss of light at 610 nm wavelength after exposing to a X radiation dose of 1.3 Mrad were measured. The results are shown in Table 1 below. Viscosity was measured with a Brookfield digital viscometer (HBDV-II CP, Borookfield, Middleboro, Mass.). Glass transition temperature was measured with a Perkin-Elmer differential scanning calorimeter (“DSC”) Model 7. Optical transmission was measured with a Perkin-Elmer Model Lambda 19 (Perkin-Elmer, Wellesley, Mass.).

TABLE 1

| | | | | Transmission |
|---|---|---|---|---|
| | | | Glass | Loss at 610 nm |
| | | Uncured | Transition | Through 1 mm |
| | | Viscosity | Temperature | Thickness |
| Epoxy Resin | Curing Agent | (kg/m/sec) | (° C.) | (%) |
| cyclohexanedimethanol | polyoxypropylenediamine | <0.2 | <25 | 1 |
| diglycidyl ether | | | | |
| cyclohexanedimethanol | isophorone diamine | 0.09 | 60 | 3 |
| diglycidyl ether | | | | |
| 1,4-butanediol diglycidyl | methylhexahydrophthalic | <0.2 | 60 | 0.8 |
| ether | anhydride | | | |
| 3,4-epoxycyclohexylmethyl- | methylhexahydrophthalic | 0.16 | 150 | 0.2 |
| 3,4-epoxycyclohexane- | anhydride | | | |
| carboxylate | | | | |
| 2,2-bis{4-(2,3-epoxy- | trimethylhexamethylene | <0.2 | 50 | 7.3 |
| propoxy)cyclohexyl}propane | diamine | | | |
| (hydrogenated bisphenol-A | | | | |
| epoxy) | | | | |
| 2,2-bis{4-(2,3-epoxy- | Isophorone diamine | 0.5 | 50 | 4.4 |
| propoxy)cyclohexyl}propane | | | | |
| 2,2-bis{4-(2,3-epoxy- | methylhexahydrophthalic | <0.2 | 82 | 0.5 |
| propoxy)cyclohexyl}propane | anhydride | | | |

In one aspect of the present invention, reflector elements comprising a cured epoxy resin composition are provided between two adjacent scintillator elements or pixels of a high-energy radiation detector array. The cured epoxy resin composition is a polymerization product of a curable composition comprising (1) at least an epoxy resin having a plurality of oxirane groups and being devoid of aromatic units; (2) at least a curing agent selected from the group consisting of aliphatic polyamines, cycloaliphatic polyamines, polyamides, aliphatic anhydrides, cycloaliphatic anhydrides, and mixtures thereof; and (3) particles of a light-scattering material dispersed in a mixture of the at least an epoxy resin and the at least a curing agent.

The present invention also provides a method of forming a reflector element in a high-energy radiation detector array comprising a plurality of scintillator elements or pixels separated by a plurality of reflector elements. In one aspect of the present invention, the reflector element is formed between two adjacent detector elements or pixels. The method comprises: (a) providing a light-scattering composition which comprises: (1) a curable epoxy resin composition that comprises: (A) at least an epoxy resin having a plurality of oxirane groups and being devoid of aromatic units; and (B) at least one curing agent selected from the group consisting of aliphatic polyamines, cycloaliphatic polyamines, polyamides, aliphatic anhydrides, cycloaliphatic anhydrides, and mixtures thereof; and (2) particles of at least a light-scattering material dispersed in said curable epoxy resin composition; (b) applying the light-scattering composition in a space between two adjacent scintillator elements; and (c) curing the curable epoxy resin composition to form the reflector elements.

The curable epoxy resin composition can be prepared by mixing together amounts of at least an epoxy resin and at least a curing agent. The amounts of the at least an epoxy resin and the at least a curing agent are selected so as to produce uncured and cured composition having desired characteristics; for example, at least one of viscosity, glass transition temperature, curing temperature, curing time, radiation-damage tolerance as measured by optical transmission loss after being exposed to high-energy radiation. It may be advantageous to provide a near-stoichiometric ratio of the epoxy resin and the curing agent. Particles of at least a light-scattering material are dispersed in the mixture of the at least an epoxy resin and the at least a curing agent. These particles may be conveniently added with the original mixture or after the mixture has been mixed for a period of time. The particles may be added in one or many increments. It may be desirable to cool the mixture while it is mixed. Particles of a radiation-damage control, such as chromium oxide, or other materials, such as cure modifiers, thermal or radiation stabilizers, may be added into the mixture in quantities that provide a desired property of the final cure epoxy. An inert solvent, such as an alkane or an aliphatic alcohol having 3-6 carbon atoms, may be added while the mixture is mixed to adjust its viscosity. The well-dispersed material is then applied into a space between two adjacent scintillator elements or pixels of the detector array; for example, by injecting, painting, spraying, or laying up sheets of the cured material in the space. The entire piece comprising the detector array and the reflector elements thus formed is then cured at a temperature and for a time so as to cure the epoxy resin composition. Curing temperature and curing time will depend on the composition of the curable epoxy resin. For example, curing temperature may be in a range from about slightly higher than room temperature to about 150° C. Curing time may be in a range from about 1 minute to about 24 hours. Curing may be conducted at one temperature, or in a step-wise or ramp increasing temperature. It may be very desirable to conduct the curing under a vacuum; i.e., at a subatmospheric pressure level, such as in a range from about 0.1 to about 700 mm mercury, so as to transport away any volatile polymerization products. It may be desirable to use a vacuum in a range from about 1 to about 500 mm mercury, and preferably from about 10 to about 300 mm mercury.

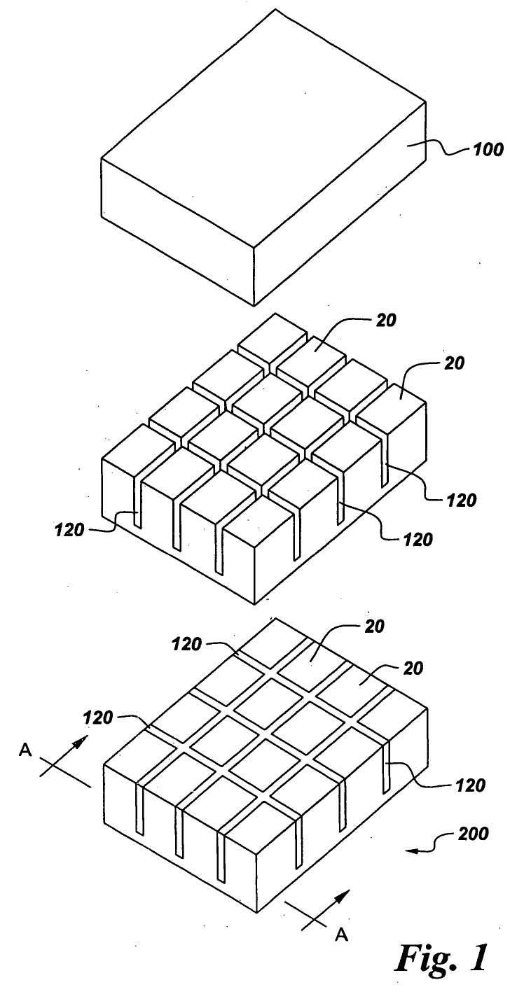

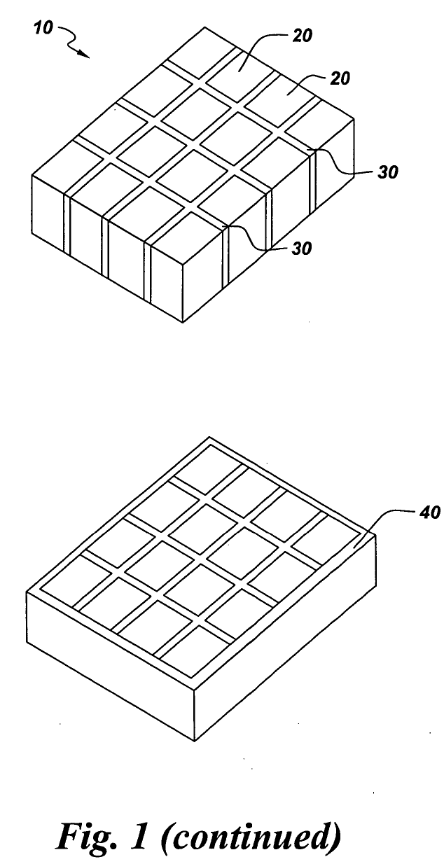

FIG. 1 shows a method of forming a high-energy radiation detector array 10 that comprises scintillator elements or pixels 20 and reflector elements 30, each being disposed between two adjacent scintillator elements or pixels. Typically, a scintillator pixel has a dimension of about 1 mm×1 mm×3 mm. It should be understood that the figures are not drawn to scale. A block 100 of a scintillator material having a thickness greater than the height of the scintillator pixels in the final detector array is provided. A series of cuts 120 are made into block 100 such that the cuts extend into but not through a thickness of block 100. Typically, a cut has a width in a range from about 0.01 mm to about 0.2 mm, and a height-to-width aspect ratio of up to about 30. In one embodiment, the width of a cut 120 is about 0.1 mm. The series of cuts 120 defines an array of scintillator pixels 20. A light-scattering curable epoxy resin composition is provided, the composition comprising at least an epoxy resin having a plurality of oxirane groups and being devoid of aromatic units; at least a curing agent selected from the group consisting of aliphatic polyamines, cycloaliphatic polyamines, polyamides, aliphatic anhydrides, cycloaliphatic anhydrides, and mixtures thereof; and particles of at least a light-scattering material dispersed therein. The cuts 120 are filled with the composition. The block 200 comprising the scintillator pixels 20 and the light-scattering curable epoxy composition is cured at a temperature and for a time sufficient to cure the curable epoxy resin composition. Then, the portion of the block 200 in which the scintillator material is continuous is cut away (along plane A-A) to produce an array 10 of scintillator elements or pixels 20 separated by reflector elements 30. A layer 40 of the light-scattering epoxy resin composition is cast around the periphery of the entire array 10 and cured. In one embodiment of the method, layer 40 is cast around block 200 before curing and cutting along plane A-A. The array may be further cleaned or polished if desired.

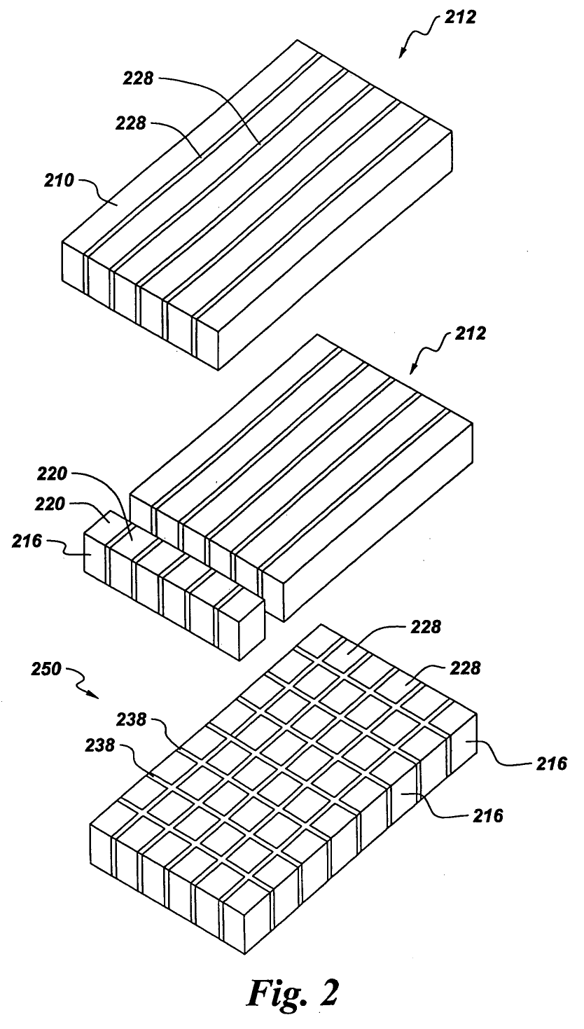

Another method of producing an array of detector elements or pixels that are separated by light-scattering material is illustrated in FIG. 2. First bars 210 of a scintillator material, each having a first, second, and third dimension, are arranged in array 212 and mounted on a fixture (not shown) along a first dimension of first bars 210 such that first bars 210 are spaced apart from each other to form first gaps 228. In one embodiment, the first dimension is equal to the final height of the scintillator elements or pixels in the detector array. For example, the first and second dimensions may be about 3 mm and 1 mm, respectively. First bars 210 are arranged such that the surfaces defined by the first and third dimensions are adjacent to one another. Gaps 228, typically, range in width from about 0.01 mm to about 0.2 mm. In one embodiment, the gap width is about 0.1 mm. Gaps 228 are then filled with a light-scattering curable epoxy resin composition of the present invention. Array 212 comprising first bars 210 and the epoxy resin composition disposed in gaps 228 is then subjected to a first curing, for example at an elevated temperature to cure the epoxy resin composition. After the first curing, array 212 is cut in the direction parallel to the surface defined by the first and second dimensions to produce a plurality of second bars 216, each comprising a series of scintillator pixels or elements 220 having desired cross-sectional area, for example about 1 mm×1 mm. The plurality of second bars 216 are then mounted on a fixture (not shown) such that second bars 216 are spaced apart from each other to form gaps 238 having a width disclosed above. Gaps 238 are then filled with a light-scattering curable epoxy resin composition of the present invention. A layer of a light-scattering curable epoxy resin composition is also applied around the periphery of plurality of second bars 216. The light-scattering curable epoxy resin composition is cured to form a block 250 of scintillator elements or pixels 220 separated by a light-scattering epoxy resin composition of the present invention. A plurality of blocks 250 is assembled to form a detector array of a desired size.

While various embodiments are described herein, it will be appreciated from the specification that various combinations of elements, variations, equivalents, or improvements therein may be made by those skilled in the art, and are still within the scope of the invention as defined in the appended claims.

1. (canceled)

2. A curable epoxy resin composition comprising:
(a) at least an epoxy resin having a plurality of oxirane groups and being devoid of aromatic units; and
(b) at least a curing agent selected from the group consisting of aliphatic polyamines, cycloaliphatic polyamines, polyamides, aliphatic anhydrides, cycloaliphatic anhydrides, and mixtures thereof;
wherein said at least an epoxy resin is selected from the group consisting of butadiene dioxide, dimethylpentane dioxide, diglycidyl ether, 1,4-butanedioldiglycidyl ether, diethylene glycol diglycidyl ether, dipentene dioxide, polyoldiglycidyl ether, and mixtures thereof.

3-4. (canceled)

5. A curable epoxy resin composition comprising:
(a) at least an epoxy resin having a plurality of oxirane groups and being devoid of aromatic units; and
(b) at least a curing agent selected from the group consisting of aliphatic polyamines, cycloaliphatic polyamines, polyamides, aliphatic anhydrides, cycloaliphatic anhydrides, and mixtures thereof;
wherein said at least an epoxy resin is selected from the group consisting of 3,4-epoxy-6-methylcyclohexylmethyl-3,4-epoxy-6-methylcyclohexanecarboxylate, vinyl cyclohexanedioxide, bis(3,4-epoxycyclohexylmethyl)adipate, bis(3,4-epoxy-6-methylcyclohexylmethyl)adipate, exo-exo bis(2,3-epoxycyclopentyl)ether, endo-exo bis(2,3-epoxycyclopentyl)ether, 2,2-bis(4-(2,3-epoxypropoxy)cyclohexyl)propane, 2,6-bis(2,3-epoxypropoxycyclohexyl-p-dioxane), 2,6-bis(2,3-epoxypropoxy)norbornene, the diglycidylether of linoleic acid dimer, limonene dioxide, 2,2-bis(3,4-epoxycyclohexyl)propane, dicyclopentadiene dioxide, 1,2-epoxy-6-(2,3-epoxypropoxy)-hexahydro-4,7-methanoindane, 1,2-bis{5-(1,2-epoxy)-4,7-hexahydromethanoindanoxyl}ethane, cyclohexanediol diglycidyl ether, and mixtures thereof; and
wherein said epoxy resin composition after being cured has an optical transmission loss of less than about 5 percent after said composition is exposed to a X-radiation dose of about 1.3 Mrad, as measured at 610 nm wavelength through a piece having a thickness of about 1 mm.

6-7. (canceled)

8. A curable epoxy resin composition comprising:
(a) at least an epoxy resin having a plurality of oxirane groups and being devoid of aromatic units; and
(b) at least a curing agent selected from the group consisting of aliphatic polyamines, cycloaliphatic polyamines, polyamides, aliphatic anhydrides, cycloaliphatic anhydrides, and mixtures thereof;
wherein said at least an epoxy resin comprises 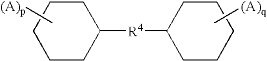
wherein A represents the glycidyl ether group 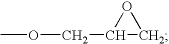
R⁴ is selected from the group consisting of —C(R⁵)(R⁶)—, R¹, R², hydroxyalkyl, hydroxyalkenyl, —R¹—N(R²)(R⁵)—, and —R¹—S—R²—, wherein R⁵ and R⁶ are independently selected from the group consisting of H, OH, alkyl, alkoxy, hydroxyalkyl, alkenyl, and hydroxyalkenyl having 1-10 carbon atoms;
R¹ and R² are independently selected from the group consisting of straight-chain saturated hydrocarbon, branched-chain saturated hydrocarbon, straight-chain unsaturated hydrocarbon, branched-chain unsaturated hydrocarbon, and halogenated hydrocarbon divalent radicals having 1-10 carbon atoms; and
p and q are independently selected from the group of integers from 1 to 5, inclusive; and
wherein said epoxy resin composition after being cured has an optical transmission loss of less than about 5 percent after said composition is exposed to a X-radiation dose of about 1.3 Mrad, as measured at 610 nm wavelength through a piece having a thickness of about 1 mm.

9. The curable epoxy resin composition of claim 8, wherein R⁴ is —C(CH₃)(CH₃)— and p=q=1.

10. The curable epoxy resin composition of claim 9 further comprising 1,4-butanedioldiglycidyl ether.

11. The curable epoxy resin composition of claim 8; wherein said at least a curing agent is selected from the group consisting of ethylenediamine; diethylenetriamine; triethylenetetramine; hexamethylenediamine; diethylaminopropylamine; menthanediamine (4-(2-aminopropane-2-yl) 1-methylcyclohexane-1-amine); silicon-containing polyamines; N-aminoethyl piperazine; H₂N—(CH₂CH₂NH)₂—(CH₂)₂OH, H₂N—R¹—NH—(CH₂)₂OH, H₂N—(CH₂)₂—NH—R¹—NH—(CH₂)₂OH; R¹⁰—(O—CH₂—CH(OH)—CH₂—NH—(CH₂)₂NH—(CH₂)₂—NH₂)₂; ketimines (R¹⁰(R¹¹)C—NR¹—NH—R²—NCR¹⁰(R¹¹)); 1,2-diaminocyclohexane; wherein R¹ and R² are independently selected from the group consisting of straight-chain saturated hydrocarbon, branched-chain saturated hydrocarbon, straight-chain unsaturated hydrocarbon, branched-chain unsaturated hydrocarbon, and halogenated hydrocarbon divalent radicals having 1-10 carbon atoms; and R¹⁰ and R¹¹ are independently selected from the group consisting of H, alkyl, alkenyl, hydroxyalkyl, and hydroxyalkenyl radicals having 1-10 carbon atoms.

12. (canceled)

13. The curable epoxy resin composition of claim 8, wherein said at least a curing agent is selected from the group consisting of polyamides having a formula
R¹⁰—(C(O)NH—R¹)ᵤ—NH—R²—NH₂,
wherein R¹ and R² are independently selected from the group consisting of straight-chain saturated hydrocarbon, branched-chain saturated hydrocarbon, straight-chain unsaturated hydrocarbon, branched-chain unsaturated hydrocarbon, and halogenated hydrocarbon divalent radicals having 1-10 carbon atoms; R¹⁰ is selected from the group consisting of H, alkyl, alkenyl, hydroxyalkyl, and hydroxyalkenyl radicals having 1-10 carbon atoms; and u is an integer from 1-10, inclusive.

14. The curable epoxy resin composition of claim 8, wherein said at least a curing agent is selected from the group consisting of acid anhydrides.

15. The curable epoxy resin composition of claim 14, wherein said acid anhydrides comprise methylbicyclo(2.2.1)heptene-2,3-dicarboxylic anhydride; tetraahydrophthalic anhydride; hexahydrophthalic anhydride; methylhexahydrophthalic anhydride (“MHHPA”); succinic anhydride; dodecenyl succinic anhydride; 1,4,5,6,7,7-hexachlorobicyclo(2.2.1)-5-heptene-2,3-dicarboxylic anhydride; endo-cis-bicyclo(2.2.1)heptene-2,3-dicarboxylic anhydride; tetrachlorophthalic anhydride; pyromellitic dianhydride; anhydride of 1,2,3,4-cyclopentanetetracarboxylic acid; and mixtures thereof.

16-42. (canceled)

43. A light-scattering composition comprising:
(a) a curable epoxy resin composition that comprises:
(1) an epoxy resin having a formula 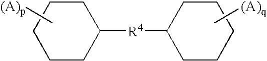
wherein A represents a glycidyl ether group 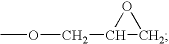
R⁴ is —C(CH₃)(CH₃)—;
p=q=1; and
(2) a curing agent comprising methylhexahydrophthalic anhydride; and
(b) particles of titanium oxide dispersed in said curable epoxy resin composition, said particles have a size of less than about 100 nm;
wherein a ratio of amounts of said epoxy resin and said curing agent is substantially stoichiometric.

44-61. (canceled)

62. A light-scattering composition comprising:
(a) a curable epoxy resin composition that comprises:
(1) at least an epoxy resin having a plurality of oxirane groups and being devoid of aromatic units; and
(2) at least one curing agent selected from the group consisting of aliphatic polyamines, cycloaliphatic polyamines, polyamides, aliphatic anhydrides, cycloaliphatic anhydrides, and mixtures thereof; and
(b) particles of at least a light-scattering material dispersed in said curable epoxy resin composition;
wherein said at least an epoxy resin is selected from the group consisting of: 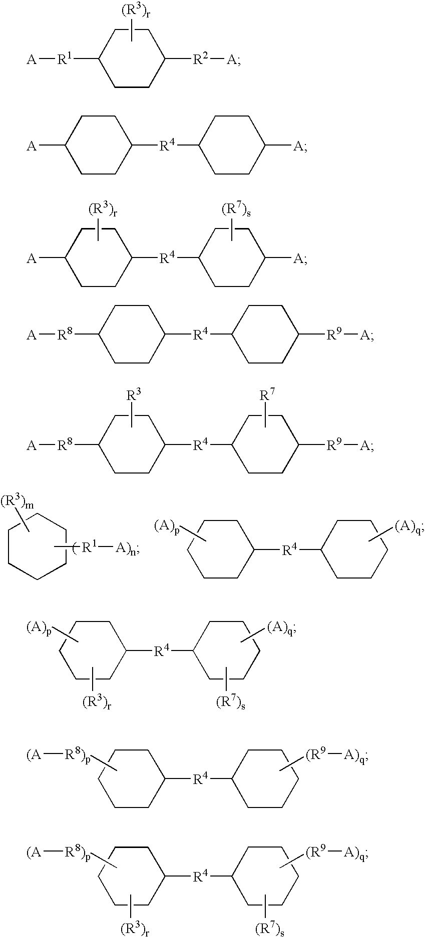
and mixtures thereof;
wherein A represents a glycidyl ether group 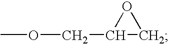
R³ and R⁷ are independently selected from the group consisting of OH, alkyl, alkenyl, hydroxyalkyl, hydroxyalkenyl, and alkoxy radicals having 1-10 carbon atoms;
R⁴, R⁸, and R⁹ are independently selected from the group consisting of —C(R⁵)(R⁶)—, R¹, R², hydroxyalkyl, hydroxyalkenyl, —R¹—N(R²)(R⁵)—, and —R¹—S—R²—, wherein R⁵ and R⁶ are independently selected from the group consisting of H, OH, alkyl, alkoxy, hydroxyalkyl, alkenyl, and hydroxyalkenyl having 1-10 carbon atoms;
n is an integer from 2 to 6, inclusive;
m is an integer from 0 to 4, inclusive;
2≦m+n≦6;
p and q are independently selected from the group of integers from 1 to 5, inclusive;
r and s are independently selected from the group of integers from 0 to 4, inclusive;
2≦p+r≦5; and 2≦q+s≦5; and
wherein said epoxy resin composition after being cured has an optical transmission loss of less than about 5 percent after said composition is exposed to a X-radiation dose of about 1.3 Mrad, as measured at 610 nm wavelength through a piece having a thickness of about 1 mm.

63. The light-scattering composition of claim 62, wherein said light-scattering material is selected from the group consisting of compounds of Groups II, III, IV, V, and VI of the Periodic Table.

64. The light-scattering composition of claim 63, wherein said light-scattering material is selected from the group consisting of titanium oxide, zirconium oxide, hafnium oxide, aluminum oxide, gallium oxide, indium oxide, yttrium oxide, cerium oxide, zinc oxide, magnesium oxide, calcium oxide, zinc selenide, zinc sulphide, gallium nitride, silicon nitride, aluminum nitride, and alloys of at least two metals of Groups II, III, IV, V, and VI of the Periodic Table.

65. The light-scattering composition of claim 62, wherein said particles have a dimension less than about 400 nm.

66. The light-scattering composition of claim 62, wherein said particles have a dimension in a range from about 250 nm to about 350 nm.

67. The light-scattering composition of claim 62, wherein said particles comprise from about 10 percent to about 85 percent by weight of a total weight of said light-scattering composition.

68. The light-scattering composition of claim 62, wherein said particles comprise from about 50 percent to about 60 percent by weight of a total weight of said light-scattering composition.

69. The light-scattering composition of claim 62, wherein said at least an epoxy resin is selected from the group consisting of butadiene dioxide, dimethylpentane dioxide, diglycidyl ether, 1,4-butanedioldiglycidyl ether, diethylene glycol diglycidyl ether, dipentene dioxide, polyoldiglycidyl ether, and mixtures thereof.

70. The light-scattering composition of claim 62, wherein said at least a curing agent is selected from the group consisting of ethylenediamine; diethylenetriamine; triethylenetetramine; hexamethylenediamine; diethylaminopropylamine; menthanediamine (4-(2-aminopropane-2-yl)1-methylcyclohexane-1-amine); silicon-containing polyamines; N-aminoethyl piperazine; H₂N—(CH₂CH₂NH)₂—(CH₂)₂OH, H₂N—R¹—NH—(CH₂)₂OH, H₂N—(CH₂)₂—NH—R¹—NH—(CH₂)₂OH; R¹⁰—(O—CH₂—CH(OH)—CH₂—NH—(CH₂)₂NH—(CH₂)₂—NH₂)₂; ketimines (R¹⁰(R¹¹)C—NR¹—NH—R²—NCR¹⁰(R¹¹)); 1,2-diaminocyclohexane; wherein R¹ and R² are independently selected from the group consisting of straight-chain saturated hydrocarbon, branched-chain saturated hydrocarbon, straight-chain unsaturated hydrocarbon, branched-chain unsaturated hydrocarbon, and halogenated hydrocarbon divalent radicals having 1-10 carbon atoms; and R¹⁰ and R¹¹ are independently selected from the group consisting of H, alkyl, alkenyl, hydroxyalkyl, and hydroxyalkenyl radicals having 1-10 carbon atoms.

71. The light-scattering composition of claim 62; wherein said at least a curing agent comprises

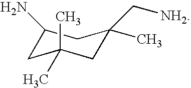

72. The light-scattering composition of claim 62, wherein said at least a curing agent is selected from the group consisting of polyamides having a formula
R¹⁰—(C(O)NH—R¹)ᵤ—NH—R²—NH₂,
wherein R¹ and R² are independently selected from the group consisting of straight-chain saturated hydrocarbon, branched-chain saturated hydrocarbon, straight-chain unsaturated hydrocarbon, branched-chain unsaturated hydrocarbon, and halogenated hydrocarbon divalent radicals having 1-10 carbon atoms; R¹⁰ is selected from the group consisting of H, alkyl, alkenyl, hydroxyalkyl, and hydroxyalkenyl radicals having 1-10 carbon atoms; and u is an integer from 1-10, inclusive.

73. The light-scattering composition of claim 62, wherein said at least a curing agent is selected from the group consisting of acid anhydrides.

74. The light-scattering composition of claim 37, wherein said acid anhydrides comprise methylbicyclo(2.2.1)heptene-2,3-dicarboxylic anhydride; tetraahydrophthalic anhydride; hexahydrophthalic anhydride; methylhexahydrophthalic anhydride (“MHHPA”); succinic anhydride; dodecenyl succinic anhydride; 1,4,5,6,7,7-hexachlorobicyclo(2.2.1)-5-heptene-2,3-dicarboxylic anhydride; endo-cis-bicyclo(2.2.1)heptene-2,3-dicarboxylic anhydride; tetrachlorophthalic anhydride; pyromellitic dianhydride; anhydride of 1,2,3,4-cyclopentanetetracarboxylic acid; and mixtures thereof.

75. A light-scattering composition comprising:
(a) a curable epoxy resin composition that comprises:
(1) at least an epoxy resin having a plurality of oxirane groups and being devoid of aromatic units; and
(2) at least a curing agent selected from the group consisting of aliphatic polyamines, cycloaliphatic polyamines, polyamides, aliphatic anhydrides, cycloaliphatic anhydrides, and mixtures thereof; and
(b) particles of at least a light-scattering material dispersed in said curable epoxy resin composition;
wherein said at least an epoxy resin is selected from the group consisting of 3,4-epoxy-6-methylcyclohexylmethyl-3,4-epoxy-6-methylcyclohexanecarboxylate, vinyl cyclohexanedioxide, bis(3,4-epoxycyclohexylmethyl)adipate, bis(3,4-epoxy-6-methylcyclohexylmethyl)adipate, exo-exo bis(2,3-epoxycyclopentyl)ether, endo-exo bis(2,3-epoxycyclopentyl)ether, 2,2-bis(4-(2,3-epoxypropoxy)cyclohexyl)propane, 2,6-bis(2,3-epoxypropoxycyclohexyl-p-dioxane), 2,6-bis(2,3-epoxypropoxy)norbornene, the diglycidylether of linoleic acid dimer, limonene dioxide, 2,2-bis(3,4-epoxycyclohexyl)propane, dicyclopentadiene dioxide, 1,2-epoxy-6-(2,3-epoxypropoxy)-hexahydro-4,7-methanoindane, p-(2,3-epoxy)cyclopentylphenyl-2,3-epoxypropylether, 1,2-bis[5-(1,2-epoxy)-4,7-hexahydromethanoindanoxyl]ethane, cyclohexanediol diglycidyl ether, and mixtures thereof.
